(19) United States
(12) Patent Application Publication
(10) Pub. No.: US 2016/0332099 A1
(43) Pub. Date: Nov. 17, 2016

(54) FILTER HAVING AN AUTOMATIC CONTROL OF FLOW

(71) Applicants: Chingshiung LIN, Pingtung (TW); Kemflo (Nanjing) Environmental Technology Co., Ltd., Nanjing (CN); Kemflo International Co., Ltd., Pingtung (TW)

(72) Inventor: Jack LIN, Nanjing (CN)

(21) Appl. No.: 14/856,647

(22) Filed: Sep. 17, 2015

(30) Foreign Application Priority Data
May 12, 2015 (CN) 201520304909.6

(51) Int. Cl. B01D 35/143; C02F 1/44; B01D 61/00; C02F 1/00

(52) U.S. Cl. CPC B01D 35/143; C02F 1/003; C02F 1/445; B01D 61/002

(57) ABSTRACT

The present invention disclosed a filter having an automatic control of flow, which contains a housing having a water inlet and a water outlet on one end, a bottom cover connecting to the other end of the housing and a filter material provided in the housing, comprising an outlet end fluidly connecting with the water outlet through a flow control unit. Based on the structure designs of the flow control unit, the filter of the present invention can remind users to replace the filter materials in an easy and visible way at the time when the filter materials reach the end of working period.

### CROSS-REFERENCE TO RELATED APPLICATION

This application claims priority from and the benefit under 35 U.S.C. §119(a) of Chinese Patent Application No. 201520304909.6, filed on May 12, 2015, which is hereby incorporated by reference for all purposes as if fully set forth herein.

### BACKGROUND OF THE INVENTION

1. FIELD OF THE INVENTION

The present invention relates to a water filter device, and more specially, to a filter having an automatic control of flow.

2. DESCRIPTION OF THE PRIOR ART

With the improvement of the quality of life, people are paying more attention to drinking water safety, so that water filter products are widely used in daily life.

Principle of filtration is flowing raw water through filter materials to catch impurities so as to obtain drinking water. The filter materials will lose effectiveness after a predetermined quantity of raw water pass through (that is, at the time that maximum rated amount of treated water is reached). Serious secondary pollution will be caused if the raw water is treated by lapsed filter materials and therefore users' safety will be at risk. Accordingly, how to remind users to replace the filter materials in time has became a hotspot in this field.

Most of current filters fail to remind users to replace the filter materials in time due to absence of reminders. However, filters that have reminders require higher manufacturing costs and more electric power to maintain operation.

Therefore, we need a new kind of filter having a simpler structure and lower manufacturing costs, which can avoid safety risks by reminding users to replace the filter materials at the time when failure occurs.

### SUMMARY OF THE INVENTION

An objective of the disclosure is to provide a filter having an automatic control of flow, which can automatically reduce water yield in order to remind users to replace the expiring filter materials by using the structure design of the flow control unit, so as to prevent users from unqualified drinking water.

For achieving the above-mentioned objective, the disclosure provides a filter having an automatic control of flow, which contains a housing having a water inlet and a water outlet on one end thereof, a bottom cover connected to the other end of the housing and a filter material provided in the housing, wherein the filter material contains an outlet end fluidly connected with the water outlet through a flow control unit.

In one embodiment according to the present invention, the flow control unit comprises a connecting cap fluidly connected with the filter material, a shell that provides a cavity and is fluidly connected with the water inlet and water outlet on the housing, wherein an annular expansion capsule is disposed in the cavity.

In one embodiment according to the present invention, a filler is provided in the annular expansion capsule.

In one embodiment according to the present invention, a first connecting portion is arranged on the axis of the external surface of the shell and is connected to the water outlet of the housing, an opening is formed on the cavity of the shell and is provided with an osmosis membrane, and the annular expansion capsule is connected with the water inlet through the osmosis membrane.

In one embodiment according to the present invention, the filler is selected from a highly concentrated solution or a super absorbent polymer.

In a preferred embodiment according to the present invention, the highly concentrated solution is solution such as sodium chloride solution.

In a preferred embodiment according to the present invention, the super absorbent polymer refers to a novel functional polymer material having an excellent performance of absorbing water and retaining water, and once absorbing water and becoming hydrogel, it is difficult to separate water from the super absorbent polymer even under pressure.

In one embodiment according to the present invention, at least one groove is formed on the first connecting portion and a sealing ring is provided in each groove.

The present invention provides a simple and effective way to automatically determine whether the amount of the treated water is reached to the predetermined amount requiring a replacement of the filter materials through the structure design of the flow control unit, especially through the structure design of the gear unit, so that users are reminded to replace the expiring filter materials.

The filter of the present invention can remind users to replace the filter materials in an easy and visible way at the time when the filter materials reach the end of working period.

### BRIEF DESCRIPTION OF THE DRAWINGS

FIG. 1 is a cross-sectional view of a filter having an automatic control of flow according to the present invention;

FIG. 2 is a cross-sectional view of a flow control unit;

FIGS. 3A and 3B are partial enlarged cross-sectional views of the flow control unit; wherein

10: housing;
20: bottom cover;
30: filter material;
40: flow control unit;
41: connecting cap;
42: shell;
43: annular expansion capsule;
44: osmosis membrane
101: water inlet;
102: water outlet;
421: first connecting portion;
422: opening;
423: groove;
424: sealing ring;
431: filler.

### DETAILED DESCRIPTION OF THE PREFERRED EMBODIMENTS

Hereinafter, the foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inner, outer, side, etc., are only directions with reference to the accompanying drawings, so that the used directional terms are used to describe and understand the present invention, but the present invention is not limited thereto. In the drawings, units with similar structures use the same numerals.

### First Embodiment

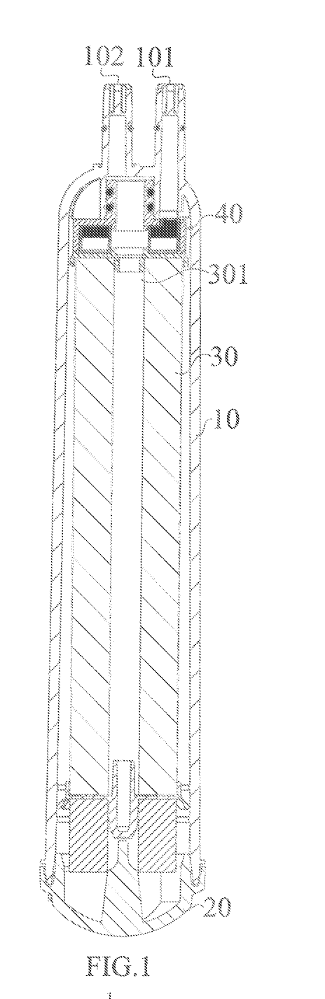

Refer now to FIG. 1, which is a cross-sectional view of a filter having an automatic control of flow according to the present invention. The filter contains a housing 10, a bottom cover 20 and a filter material 30. The filter material 30 is provided in the housing 10, a water inlet 101 and a water outlet 102 are provided on one end of the housing 10 and the bottom cover 20 is connected to the other end of the housing 10. The filter material 30 comprises an outlet end 301 fluidly connected with the water outlet 102 through a flow control unit 40.

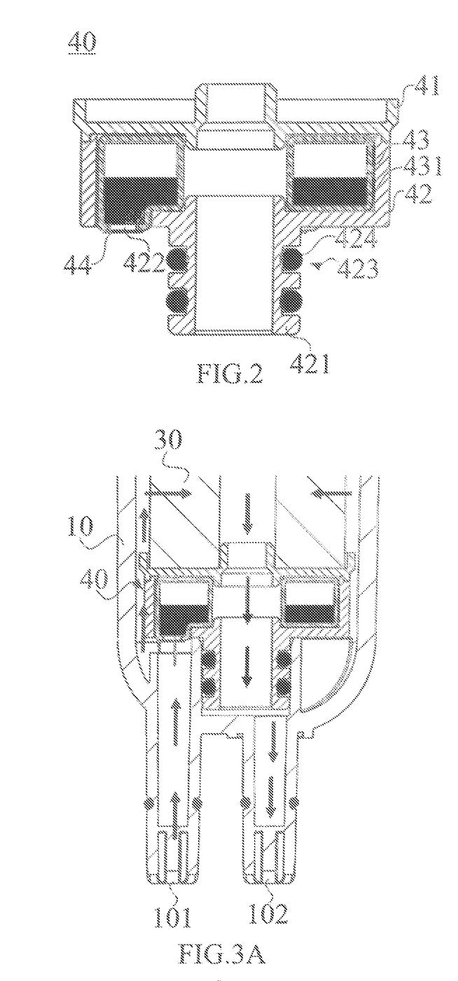

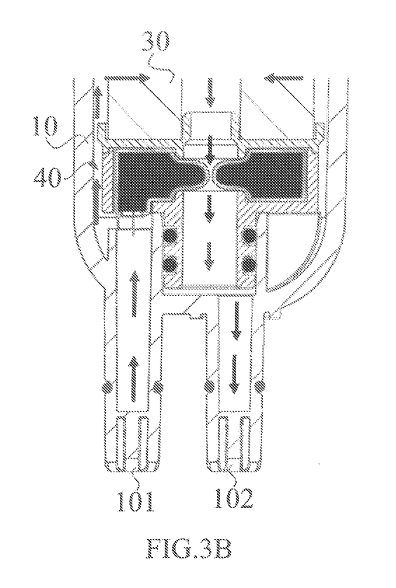

Hereinafter, the flow control unit 40 will be described in detail by referring to the following detailed description and FIGS. 2 to 3B.

The flow control unit 40 comprises a connecting cap 41 fluidly connected with the filter material 30, a shell 42 providing a cavity and fluidly connected with the water inlet 101 and water outlet 102 on the housing 10. An annular expansion capsule 43 is disposed in the cavity. A first connecting portion 421 is arranged on the axis of the external surface of the shell 42 and is connected to the water outlet 102 of the housing 10. An opening 422 is formed on the cavity and is provided with an osmosis membrane 44. As shown in FIGs, the annular expansion capsule 43 is connected with the water inlet 101 through the osmosis membrane 44.

As shown in the FIGs, at least one groove 423 is formed on the first connecting portion 421 and a sealing ring 424 is provided in each groove 423. In this way, the connecting cap 42 is tightly connected with the water outlet 102.

As shown in the FIGs, a filler 431 is provided in the annular expansion capsule 43.

In a preferred embodiment according to the present invention, the filler 431 is selected from a highly concentrated solution, such as sodium chloride solution, or a super absorbent polymer. And in a preferred embodiment according to the present invention, the super absorbent polymer refers to a novel functional polymer material having an excellent performance of absorbing water and retaining water. And once the super absorbent polymer absorbs water and becomes hydrogel, it is difficult to separate water from the super absorbent polymer even under pressure.

As shown in FIGS. 3A and 3B, arrows show the direction of water flow. When using the filter of the present invention, raw water is filtered by the filter material after flowing into the filter through the water inlet and then treated water flows into the flow control unit followed by flowing to the water outlet. Meanwhile, since the osmosis membrane is disposed at the water inlet, parts of the raw water enters into the annular expansion capsule through the osmosis membrane based on the principle of osmosis, so that the volume of the highly concentrated solution is increased or the super absorbent polymer expands due to the reaction with the raw water. And then the annular expansion capsule expands to block the water outlet of the flow control unit, so that the quantity of drinking water will be reduced to achieve the purpose of reminding users to replace the expiring filter materials.

The present invention provides a simple and effective way to automatically determine whether the amount of the treated water is reached to the predetermined amount requiring a replacement of the filter materials through the structure design of the flow control unit, especially through the structure designs of the gear set, so that users can be reminded to replace the expiring filter materials.

The filter of the present invention can remind users to replace the filter materials in an easy and visible way at the time when the filter materials reach the end of working period.

The embodiment described in the present specification and the attached drawings are merely illustrative for describing part of the technical spirit included in the present invention. Accordingly, the embodiment disclosed in the present specification is not intended to be limiting but is merely a description of the technical spirit of the present invention. Thus, it is apparent that the scope of the technical spirit of the present invention is not limited by this embodiment. It should be interpreted that other modifications and specific embodiments which those with ordinary knowledge in the art can easily infer within the scope of the technical spirit included in the specification and drawings of the present invention also fall within the technical scope of the present invention.

What is claimed is:

1. A filter having an automatic control of flow, which contains a housing having a water inlet and a water outlet on one end, a bottom cover connecting to the other end of the housing and a filter material provided in the housing, comprising an outlet end fluidly connecting with the water outlet through a flow control unit.

2. The filter according to claim 1, wherein the flow control unit comprises a connecting cap fluidly connecting with the filter material, a shell that provides a cavity and fluidly connects with the water inlet and water outlet on the housing, wherein an annular expansion capsule is disposed in the cavity.

3. The filter according to claim 2, wherein a filler is provided in the annular expansion capsule.

4. The filter according to claim 3, wherein a first connecting portion is arranged on the axis of the external surface of the shell and is connected to the water outlet of the housing, an opening is formed on the cavity and is provided with an osmosis membrane, and the annular expansion capsule is connected with the water inlet through the osmosis membrane.

5. The filter according to claim 4, wherein the filler is selected from a highly concentrated solution or a super absorbent polymer.

6. The filter according to claim 1, wherein at least one groove is formed on the first connecting portion and a sealing ring is provided in each groove.
